(19) United States
(12) Patent Application Publication
(10) Pub. No.: US 2014/0024228 A1
(43) Pub. Date: Jan. 23, 2014

(54) SECONDARY BATTERY PACK FORMED BY BRIDGE CONNECTION OF SECONDARY BATTERY CELLS AND FUSES

(71) Applicant: ENERGY CONTROL LIMITED, Tortola (VG)

(72) Inventor: Donald P.H. WU, Hsinchu County (TW)

(73) Assignee: ENERGY CONTROL LIMITED, Tortola (VG)

(21) Appl. No.: 13/738,784

(22) Filed: Jan. 10, 2013

(30) Foreign Application Priority Data
Jul. 23, 2012 (TW) 101126420

(51) Int. Cl. H01M 10/42

(52) U.S. Cl. CPC H01M 10/425
USPC 439/61

(57) ABSTRACT

A safety secondary battery pack formed by bridge connection of secondary battery cells and fuses is provided with a plurality of secondary battery cell groups and fuses, wherein the secondary battery cells and the fuses are connected in bridge mode, each of the positive or negative terminals of the secondary battery cells is provided with a fuse. Hence, the respective battery cell groups of the present invention can still work properly in the case that any single battery cell fails. When any of the secondary battery cells fails and the current flowing through the fuse exceeds the rated value, the fuse electrically connected to the failed secondary battery cell will be blown to stop current from flowing, so that the failed secondary battery cell is isolated from the rest good secondary battery cells to improve safety of the battery pack.

### BACKGROUND OF THE INVENTION

1. Field of the Invention

The present invention relates to a secondary battery pack, and more particularly to a safety secondary battery pack formed by bridge connection of secondary battery cells and fuses.

2. Description of the Prior Art

The existing secondary batteries are mostly provided with a great number of single secondary battery cells which are connected in series or parallel in order to have a high output capacity.

Since the single secondary battery cells are connected in series or in parallel, when any of battery cells is broken, it may lead to the failure of the whole secondary battery pack. Moreover, if the bad battery cell is not electrically isolated from other good ones, it will lead to the failure of the good battery cells or may even affect the safety of the whole battery pack.

The present invention has arisen to mitigate and/or obviate the afore-described disadvantages.

### SUMMARY OF THE INVENTION

The primary object of the present invention is to provide a safety secondary battery pack formed by bridge connection of secondary battery cells and fuses, wherein the secondary battery cells and the fuses are connected in bridge mode, each of the positive or negative terminals of the secondary battery cells is provided with a fuse. Hence, the respective battery cell groups of the present invention can still work properly in the case that any single battery cell fails. When any of the secondary battery cells fails and the current flowing through the fuse exceeds the rated value, the fuse electrically connected to the failed secondary battery cell will be blown to stop current from flowing, so that the failed secondary battery cell is isolated from the rest good secondary battery cells to improve safety of the battery pack.

To achieve the above object, a secondary battery pack in accordance with the present invention comprises a first secondary battery cell group, a second secondary battery cell group, a first bridge wire, a first fuse group, and a second fuse group. The first secondary battery cell group includes a first secondary battery cell and a second secondary battery cell which are connected in series, the first secondary battery cell includes a first positive terminal and a first negative terminal, and the second secondary battery cell includes a second positive terminal electrically connected to the first negative terminal, and a second negative terminal. The second secondary battery cell group includes a third secondary battery cell and a fourth secondary battery cell which are connected in series, the third secondary battery cell includes a third positive terminal and a third negative terminal, the fourth secondary battery cell includes a fourth positive terminal electrically connected to the third negative terminal, and a fourth negative terminal. The first bridge wire is bridge-connected between the first and second secondary battery cell groups and includes a first front end electrically connected between the first negative terminal and the second positive terminal, and a first rear end electrically connected between the third negative terminal and the fourth positive terminal. The first fuse group includes a first fuse electrically connected between the first negative or positive terminal and the first front end, and a second fuse electrically connected between the second negative or positive terminal and the first front end. The second fuse group includes a third fuse electrically connected between the third positive or negative terminal and the first rear end, and a fourth fuse electrically connected between the fourth negative or positive terminal and the first rear end.

### BRIEF DESCRIPTION OF THE DRAWINGS

FIG. 1 is an illustrative view of a secondary battery pack formed by bridge connection of secondary battery cells and fuses in accordance with a first embodiment of the present invention;

FIG. 2 is an illustrative view of a secondary battery pack formed by bridge connection of secondary battery cells and fuses in accordance with a second embodiment of the present invention;

FIG. 3 is an illustrative view of a secondary battery pack formed by bridge connection of secondary battery cells and fuses in accordance with a third embodiment of the present invention;

FIG. 4 is an illustrative view of a secondary battery pack formed by bridge connection of secondary battery cells and fuses in accordance with a fourth embodiment of the present invention;

FIG. 5 is an illustrative view of a secondary battery pack formed by bridge connection of secondary battery cells and fuses in accordance with a fifth embodiment of the present invention; and

FIG. 6 is an illustrative view of a secondary battery pack formed by bridge connection of secondary battery cells and fuses in accordance with a sixth embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

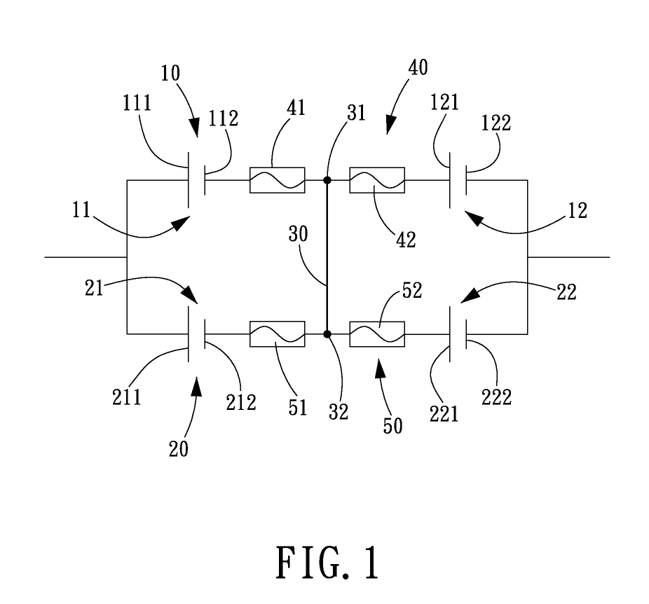

Referring to FIG. 1, a safety secondary battery pack formed by bridge connection of secondary battery cells and fuses in accordance with a first embodiment of the present invention comprises: a first secondary battery cell group 10, a second secondary battery cell group 20, a first bridge wire 30, a first fuse group 40, and a second fuse group 50.

The first secondary battery cell group 10 includes a first secondary battery cell 11 and a second secondary battery cell 12 which are connected in series. The first secondary battery cell 11 includes a first positive terminal 111 and a first negative terminal 112. The second secondary battery cell 12 includes a second positive terminal 121 electrically connected to the first negative terminal 112, and a second negative terminal 122.

The second secondary battery cell group 20 includes a third secondary battery cell 21 and a fourth secondary battery cell 22 which are connected in series. The third secondary battery cell 21 includes a third positive terminal 211 electrically connected to the first positive terminal 111, and a third negative terminal 212. The third positive terminal 211 serves as a positive output terminal of the whole safety secondary battery pack. The fourth secondary battery cell 22 includes a fourth positive terminal 221 electrically connected to the third negative terminal 212, and a fourth negative terminal 222 which is electrically connected to the second negative terminal 122 and used as a negative output terminal of the whole safety secondary battery pack.

The first bridge wire 30 is bridge-connected between the first and second secondary battery cell groups 10, 20 and includes a first front end 31 electrically connected between the first negative terminal 112 and the second positive terminal 121, and a first rear end 32 electrically connected between the third negative terminal 212 and the fourth positive terminal 221.

The first fuse group 40 includes a first fuse 41 electrically connected between the first negative terminal 112 and the first front end 31, and a second fuse 42 electrically connected between the second positive terminal 121 and the first front end 31.

The second fuse group 50 includes a third fuse 51 electrically connected between the third negative terminal 212 and the first rear end 32, and a fourth fuse 52 electrically connected between the fourth positive terminal 221 and the first rear end 32.

What mentioned above are the structural relations of the main components of the secondary battery pack of the first embodiment. In addition to the fact that the secondary battery cells and the fuses are connected in bridge mode, each of the positive or negative terminals of the secondary battery cells is provided with a fuse.

The first bridge wire 30 is bridge-connected between the first and second secondary battery cell groups 10, 20 to form a circuit loop. When one of or all secondary battery cells of the first or second secondary battery cell groups 10, 20 fails and results in the current flowing through the fuse exceeding the rated value, the fuse electrically connected to the failed secondary battery cell will be blown to stop current from flowing, so that the failed secondary battery cell is isolated from the rest good secondary battery cells to improve safety of the battery pack.

Furthermore, since the first bridge wire 30 is bridge-connected between the first and second secondary cell groups 10, 20 to form a circuit loop, when one of the secondary battery cells of the first or second secondary battery cell groups 10, 20 fails, another one of the secondary battery cells that doesn't fail can still work and output power. For example, when the first secondary battery cell 11 fails, in addition to the second secondary battery cell group 20 will output power, the second secondary battery cell 12 is still capable of outputting power since it is electrically connected to the second secondary battery cell group 20 by the first bridge wire 30. Hence, the respective battery cell groups can still work properly in the case that any single battery cell fails.

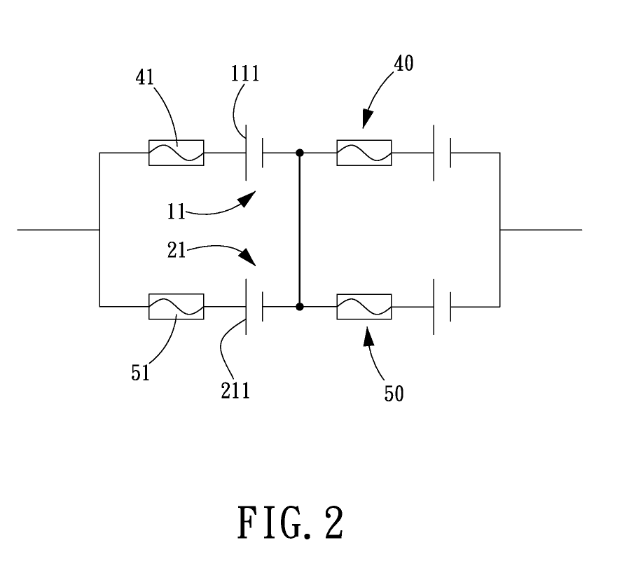

Referring to FIG. 2, a secondary battery pack formed by bridge connection of secondary battery cells and fuses in accordance with a second embodiment of the present invention is similar to the first embodiment, except that: the first fuse 41 is electrically connected to the first positive terminal 111 of the first secondary battery cell 11, and the third fuse 51 is electrically connected to the third positive terminal 211 of the third secondary battery cell 21.

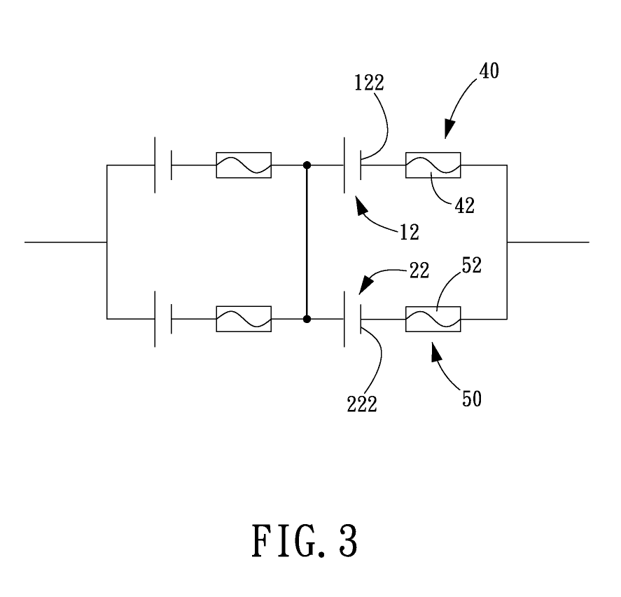

Referring to FIG. 3, a secondary battery pack formed by bridge connection of secondary battery cells and fuses in accordance with a third embodiment of the present invention is similar to the first embodiment, except that: the second fuse 42 is electrically connected to the second negative terminal 122 of the second secondary battery cell 12, and the fourth fuse 52 is electrically connected to the fourth negative terminal 222 of the fourth secondary battery cell 22.

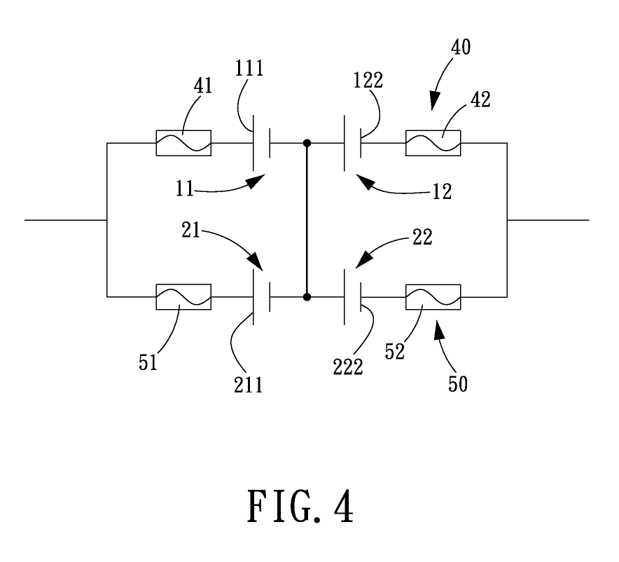

Referring to FIG. 4, a secondary battery pack formed by bridge connection of secondary battery cells and fuses in accordance with a fourth embodiment of the present invention is similar to the first embodiment, except that: the first fuse 41 is electrically connected to the first positive terminal 111 of the first secondary battery cell 11, the second fuse 42 is electrically connected to the second negative terminal 122 of the second secondary battery cell 12, the third fuse 51 is electrically connected to the third positive terminal 211 of the third secondary battery cell 21, and the fourth fuse 52 is electrically connected to the fourth negative terminal 222 of the fourth secondary battery cell 22.

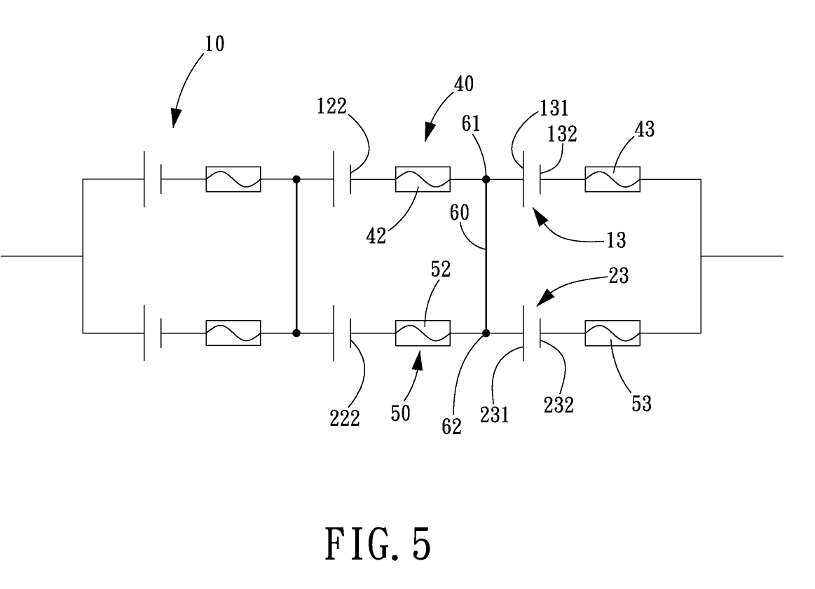

Referring to FIG. 5, a secondary battery pack formed by bridge connection of secondary battery cells and fuses in accordance with a fifth embodiment of the present invention is similar to the first embodiment, except that: the secondary battery pack further comprises a second bridge wire 60, the first secondary battery cell group 10 further comprises a fifth secondary battery cell 13, the second secondary battery cell group 20 further comprises a sixth secondary battery cell 23, the first fuse group 40 further comprises a fifth fuse 43, and the second fuse group 50 further comprises a sixth fuse 53.

The fifth secondary battery cell 13 includes a fifth positive terminal 131 electrically connected to the second negative terminal 122, and a fifth negative terminal 132.

The sixth secondary battery cell 23 includes a sixth positive terminal 231 electrically connected to the fourth negative terminal 222, and a sixth negative terminal 232 which is electrically connected to the fifth negative terminal 132 and serves as an output terminal of the whole safety secondary battery pack.

The second bridge wire 60 is connected between the first and second secondary battery cell groups 10, 20 and includes a second front end 61 electrically connected between the second negative terminal 122 and the fifth positive terminal 131, and a second rear end 62 electrically connected between the fourth negative terminal 222 and the sixth positive terminal 231. The second fuse 42 is located between the second negative terminal 122 and the second front end 61, and the fourth fuse 52 is located between the fourth negative terminal 222 and the second rear end 62.

The fifth fuse 43 is electrically connected to the fifth negative terminal 132 (or connected between the fifth positive terminal 131 and the second front end 61, not shown), and the sixth fuse 53 is electrically connected to the sixth negative terminal 232 (or connected between the sixth positive terminal 231 and the second rear end 62, not shown).

In addition to having the same function and effect as the first embodiment, the fifth embodiment of the present invention further improves the voltage of the whole secondary battery pack.

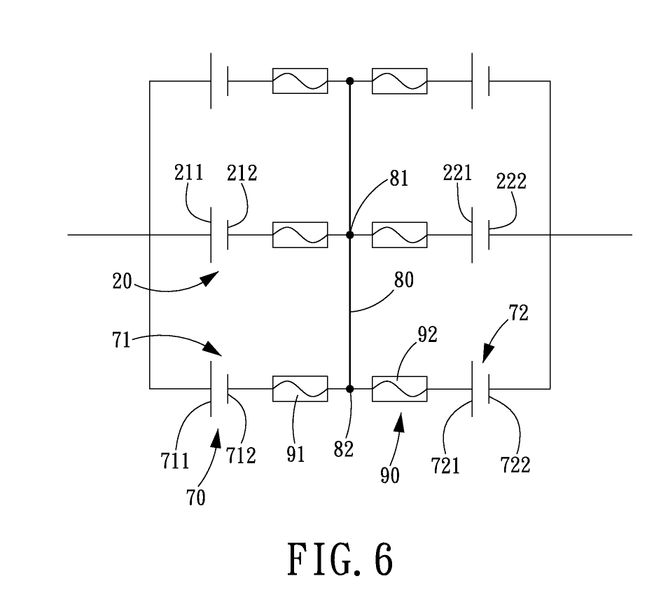

Referring to FIG. 6, a secondary battery pack in accordance with a sixth embodiment of the present invention is shown and similar to the first embodiment, except that: the secondary battery pack further comprises a third secondary battery cell group 70, a third bridge wire 80 and a third fuse group 90.

The third secondary battery cell group 70 includes a seventh secondary battery cell 71 and an eighth secondary battery cell 72 which are connected in series. The seventh secondary battery cell 71 includes a seventh positive terminal 711 electrically connected to the third positive terminal 211 and a seventh negative terminal 712. The eighth secondary battery cell 72 includes a eighth positive terminal 721 electrically connected to the seventh negative terminal 712, and a eighth negative terminal 722 electrically connected to the fourth negative terminal 222.

The third bridge wire 80 is bridge-connected between the second and third secondary battery cell groups 20, 70 and includes a third front end 81 electrically connected between the third negative terminal 212 and the fourth positive terminal 221, and a third rear end 82 electrically connected between the seventh negative terminal 712 and the eighth positive terminal 721.

The third fuse group 90 includes a seventh fuse 91 electrically connected between the seventh negative terminal 712 and the third rear end 82 (or electrically connected to the seventh positive terminal 711 not shown), and a eighth fuse 92 electrically connected between the eighth positive terminal 721 and the third rear end 82 (or electrically connected to the eighth negative terminal 722 not shown).

In addition to having the same function and effect as the first embodiment, the sixth embodiment of the present invention further increases the power of the whole secondary battery pack.

While we have shown and described various embodiments in accordance with the present invention, it is clear to those skilled in the art that further embodiments may be made without departing from the scope of the present invention.

What is claimed is:

1. A secondary battery pack formed by bridge connection of secondary battery cells and fuses comprising:
a first secondary battery cell group including a first secondary battery cell and a second secondary battery cell which are connected in series, the first secondary battery cell including a first positive terminal and a first negative terminal, the second secondary battery cell including a second positive terminal electrically connected to the first negative terminal, and a second negative terminal;
a second secondary battery cell group including a third secondary battery cell and a fourth secondary battery cell which are connected in series, the third secondary battery cell including a third positive terminal and a third negative terminal, the fourth secondary battery cell including a fourth positive terminal electrically connected to the third negative terminal, and a fourth negative terminal;
a first bridge wire bridge-connected between the first and second secondary battery cell groups and including a first front end electrically connected between the first negative terminal and the second positive terminal, and a first rear end electrically connected between the third negative terminal and the fourth positive terminal;
a first fuse group including a first fuse electrically connected between the first negative or positive terminal and the first front end, and a second fuse electrically connected between the second negative or positive terminal and the first front end; and
a second fuse group including a third fuse electrically connected between the third positive or negative terminal and the first rear end, and a fourth fuse electrically connected between the fourth negative or positive terminal and the first rear end.

2. The secondary battery pack formed by bridge connection of secondary battery cells and fuses as claimed in claim 1, wherein the third positive terminal of the third secondary battery cell is electrically connected to the first positive terminal of the first secondary battery cell, and the second negative terminal of the second secondary battery cell is electrically connected to the fourth negative terminal of the fourth secondary battery cell.

3. The secondary battery pack formed by bridge connection of secondary battery cells and fuses as claimed in claim 1, wherein the first fuse is electrically connected between the first negative terminal and the first front end, the second fuse is electrically connected between the second positive terminal and the first front end, the third fuse is electrically connected between the third negative terminal and the first rear end, and the fourth fuse is electrically connected between the fourth positive terminal and the first rear end.

4. The secondary battery pack formed by bridge connection of secondary battery cells and fuses as claimed in claim 1, wherein the first fuse is electrically connected to the first positive terminal of the first secondary battery cell, the second fuse is electrically connected between the second positive terminal and the first front end, the third fuse is electrically connected between the third positive terminal, and the fourth fuse is electrically connected between the fourth positive terminal and the first rear end.

5. The secondary battery pack formed by bridge connection of secondary battery cells and fuses as claimed in claim 1, wherein the first fuse is electrically connected between the first negative terminal and the first front end, the second fuse is electrically connected to the second negative terminal, the third fuse is electrically connected between the third negative terminal and the first rear end, and the fourth fuse is electrically connected between the fourth negative terminal.

6. The secondary battery pack formed by bridge connection of secondary battery cells and fuses as claimed in claim 1, wherein the first fuse is electrically connected to the first positive terminal of the first secondary battery cell, the second fuse is electrically connected to the second negative terminal, the third fuse is electrically connected to the third positive terminal of the third secondary battery cell, and the fourth fuse is electrically connected to the fourth negative terminal.

7. The secondary battery pack formed by bridge connection of secondary battery cells and fuses as claimed in claim 1 further comprises a second bridge wire, the first secondary battery cell group further comprises a fifth secondary battery cell, the second secondary battery cell group further comprises a sixth secondary battery cell, the first fuse group further comprises a fifth fuse, and the second fuse group further comprises a sixth fuse;
the fifth secondary battery cell includes a fifth positive terminal electrically connected to the second negative terminal, and a fifth negative terminal;
the sixth secondary battery cell includes a sixth positive terminal electrically connected to the fourth negative terminal, and a sixth negative terminal;
the second bridge wire is connected between the first and second secondary battery cell groups and includes a second front end electrically connected between the second negative terminal and the fifth positive terminal, and a second rear end electrically connected between the fourth negative terminal and the sixth positive terminal; and
the fifth fuse is electrically connected to the fifth negative terminal or connected between the fifth positive terminal and the second front end, and the sixth fuse is electrically connected to the sixth negative terminal or connected between the sixth positive terminal and the second rear end.

8. The secondary battery pack formed by bridge connection of secondary battery cells and fuses as claimed in claim 7, wherein the first positive terminal of the first secondary battery cell is electrically connected to the third positive terminal of the third secondary battery cell, and the fifth negative terminal of the fifth secondary battery cell is electrically connected to the sixth negative terminal of the sixth secondary battery cell.

9. The secondary battery pack formed by bridge connection of secondary battery cells and fuses as claimed in claim 1 further comprises a third secondary battery cell group, a third bridge wire and a third fuse group;
the third secondary battery cell group includes a seventh secondary battery cell and an eighth secondary battery cell which are connected in series, the seventh secondary battery cell includes a seventh positive terminal and a seventh negative terminal, the eighth secondary battery cell includes a eighth positive terminal electrically connected to the seventh negative terminal, and a eighth negative terminal;
the third bridge wire is bridge-connected between the second and third secondary battery cell groups and includes a third front end electrically connected between the third negative terminal and the fourth positive terminal, and a third rear end electrically connected between the seventh negative terminal and the eighth positive terminal;
the third fuse group includes a seventh fuse which is electrically connected between the seventh negative terminal and the third rear end or electrically connected to the seventh positive terminal, and an eighth fuse which is electrically connected between the eighth positive terminal and the third rear end or electrically connected to the eighth negative terminal.

10. The secondary battery pack formed by bridge connection of secondary battery cells and fuses as claimed in claim 9, wherein the first positive terminal of the first secondary battery cell and the third positive terminal of the third secondary battery cell are electrically connected to the seventh positive terminal, and the second negative terminal of the second secondary battery cell and the fourth negative terminal of the fourth secondary battery cell are electrically connected to the eighth negative terminal of the eight secondary battery cell.
